(19) United States
(12) Patent Application Publication
(10) Pub. No.: US 2005/0247376 A1
(43) Pub. Date: Nov. 10, 2005

(54) Magnetic materials containing praseodymium

(76) Inventors: Wen Cheng Chang, Minshiung Township (TW); Huang Wei Chang, Minshiung Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/960,955

(22) Filed: Oct. 12, 2004

(30) Foreign Application Priority Data
May 7, 2004 (TW) 093112867

(51) Int. Cl. H01F 1/057

(52) U.S. Cl. 148/302

(57) ABSTRACT

A magnetic material containing praseodymium has the ternary alloy PrFeB as the primary component. Through an appropriate adjustment of composition, the magnetic material has both high remanent magnetization and magnetic energy prone to magnetization. The rare earth element praseodymium has the characteristics of easy availability and low price as compared to the rare earth element neodymium, and therefore is used to accomplish a low-cost economic benefit and good low-temperature magnetic properties of the high-performance magnetic material. Moreover, praseodymium is replaced with a trace of neodymium to enhance the remanent magnetization of the alloy ribbon. Through addition of refractory element, the microstructure of the alloy ribbon can be improved to enhance the magnetic energy thereof.

### FIELD OF THE INVENTION

The present invention relates to a magnetic material and, more particularly, to a composition of magnetic material containing praseodymium.

### BACKGROUND OF THE INVENTION

Since the ternary neodymium, iron and boron (NdFeB) permanent magnet was developed in 1983, its magnetic property has become representative of today's permanent magnet. The requirement for its application in bonded magnet increases more and more, and it has become a main force of commercial mass production. New generation materials give first place to dual-phase exchange-coupled nanocomposite magnetic powder of iron-rich or boron-rich neodymium, iron and boron compounds, i.e., α-Fe/R₂Fe₁₄B or Fe₃B/R₂Fe₁₄B, where R is a rare-earth element, usually being neodymium (Nd). This nanocomposite magnetic powder makes use of soft magnetic phase α-Fe or Fe₃B to provide a high saturation magnetization and hard magnetic phase R₂Fe₁₄B to provide a higher anisotropic magnetic field. Because this magnetic powder consists of nanoscale grains, its maximum energy product is greater enhanced as a result of exchange-coupling effect between soft and hard phases.

Although iron-rich or boron-rich neodymium, iron and boron compound magnetic powder has a higher maximum energy product, however, increase of the volume fraction of the soft magnetic phase α-Fe or Fe₃B leads to the reduction of the volume fraction of the hard magnetic phase R₂Fe₁₄B, the intrinsic coercive force is thus reduced, normally smaller than 7 kOe, hence lowering the temperature range of application. In order to improve the above deficiency, it is needed to improve the intrinsic coercive force of the magnetic powders to be larger than 7 kOe.

However, for nanocomposite RFeB powder, on the other hand, the coercive force should not be too large to be magnetized. One object of the present invention is to search for a magnetic powder composition having high remanent magnetization and magnetic energy product prone to magnetization to provide materials for making multi-pole ring-shaped magnets.

Furthermore, the magnetic spin of Nd₂Fe₁₄B phase will reorient at temperatures below 150 K to deteriorate its magnetic property, which limits its application at low-temperature environments. Although the saturation magnetization of Pr₂Fe₁₄B (15.6 kG) is slightly lower than that of Nd₂Fe₁₄B (16 kG), its anisotropic magnetic field is 87 kOe, much higher that 67 kOe of Nd₂Fe₁₄B. Moreover, Pr₂Fe₁₄B phase has no spin reorientation at temperatures below 150 K. Therefore, Pr—Fe—B type nanocomposite ribbons become another alternative materials for making bonded magnets.

Accordingly, the present invention aims to propose a composition design of high-performance magnetic powder prone to magnetization to effectively conquer the material drawbacks of the conventional bonded magnet.

### SUMMARY AND OBJECT OF THE PRESENT INVENTION

An object of the present invention is to provide a magnetic material containing praseodymium, which use the ternary alloy PrFeB as the primary component. Through an appropriate adjuetment of composition, the magnetic material has both high remanent magnetization and magnetic energy product prone to magnetization. The magnetic material can thus apply to multi-pole ring-shaped magnets.

Another object of the present invention is to provide compositions of permanent magnet containing praseodymium, which have the advantage of easy availability of rare-earth raw material so that the high-performance magnetic material has also the low-cost economic benefit.

Yet another object of the present invention is to provide magnetic materials having the ternary alloy PrFeB as the primary component. Through a slight replacement of Pr with Nd, the whole saturation magnetization of the alloy ribbon can be enhanced. Moreover, through series changing of process parameters, the microstructure can be optimized to increase the remanent magnetization and maximum energy product and also provide an appropriate coercive force.

Still yet another object of the present invention is to provide permanent magnets containing praseodymium having a good low-temperature characteristic, whose magnetic property won't deteriorate due to a decrease of temperature. The permanent magnets can thus apply to low-temperature environments.

According to the present invention, a magnetic material containing praseodymium is formed of a composition whose atomic percentage composition is (PrNd)ₓT_{100-x-y-x}X_{y}Q_{z}, where (PrNd) represents one or more than one element selected from the group composed of praseodymium and neodymium and contains definitely praseodymium, T is more than one element selected from the group composed of iron and cobalt, X is a refractory element, Q is more than one element selected from the group composed of boron and carbon. The composition ratios x, y, z, and w satisfy: 8≦x≦11 atomic percentage; 0≦y≦3 atomic percentage; and 6≦z≦12 atomic percentage.

The various objects and advantages of the present invention will be more readily understood from the following detailed description when read in conjunction with the appended drawings, in which:

### BRIEF DESCRIPTION OF DRAWING

FIG. 1 is a diagram showing the manufacturing process of alloy ribbon of the present invention;

FIGS. 2A to 2F are diagrams showing hysteresis curves of magnet whose composition is Nd_{9.5}Fe_{bal.}Ti₁Nb_{0.5}Zr_{0.5}B₉ at different temperatures; and

FIGS. 3A to 3F are diagram showing hysteresis curves of magnet whose composition is Pr_{9.5}Fe_{bal.}Ti₁Nb_{0.5}Zr_{0.5}B₉ at different temperatures.

### DETAILED DESCRIPTION OF PREFERRED EMBODIMENT

The present invention replaces Nd₂Fe₁₄B with Pr₂Fe₁₄B having higher anisotropic magnetic field to enhance the intrinsic coercive force (ᵢH_{c}) and the squareness of the demagnetization curve of magnetic alloy ribbon at the room temperature or at low temperatures. The present invention first gives develops the PrFeB-type magnetic powder having high performance and prone to magnetization. Next, Pr is replaced with a slight Nd to enhance the whole saturation magnetization of the alloy ribbon. Moreover, through series changing of process parameters, the microstructure can be optimized to enhance the exchange-coupling effect between soft and hard magnetic phases, thereby increasing the remanent magnetization and maximum energy product and also providing an appropriate coercive force.

A magnetic material containing praseodymium of the present invention is composed of a composition whose atomic percentage composition is (PrNd)ₓT_{100-x-y-z}X_{y}Q_{z}, where (PrNd) represents one or more than one element selected from the group composed of praseodymium and neodymium and contains definitely praseodymium, T is more than one element selected from the group composed of iron and cobalt, X is a refractory element, Q is more than one element selected from the group composed of boron and carbon. The composition ratios x, y and z satisfy: 8≦x≦11 atomic percentage; 0≦y≦3 atomic percentage; and 6≦z≦12 atomic percentage.

The material structure of this magnetic material containing praseodymium includes one hard magnetic phase and at least one soft magnetic phase. The soft magnetic phase is usually α-Fe or Fe₃B to provide a high saturation magnetization. The hard magnetic phase is usually (PrNd)₂Fe₁₄B to provide a higher anisotropic magnetic field. The soft magnetic phase has a crystalline grain size of 10 to 30 nm (preferred to be 10 to 20 nm), while the hard magnetic phase has a crystalline grain size of 20 to 50 nm (preferred to be 20 to 30 nm). The soft magnetic phase usually has a volume percentage of 5 to 25%, while the hard magnetic phase usually has a volume percentage of 75 to 95%.

As compared to the conventional NdFeB bonded magnet, the present invention replaces Nd with Pr and use the ternary alloy PrFeB as the primary component. Therefore, the present invention has the advantage of easy availability of rare-earth raw material so that the high-performance magnetic material has also the low-cost economic benefit. Moreover, through an appropriate adjustment of composition and series changing of process parameters, the microstructure of the magnetic material can be optimized to enhance the exchange-coupling effect between soft and hard magnetic phases, thereby increasing the remanent magnetization and maximum energy product and also providing an appropriate coercive force.

Therefore, the present invention not only can achieve the magnetic performance of conventional NdFeB magnet, but can also effectively conquer material drawbacks of conventional bonded magnet to have both high remanent magnetization and magnetic energy prone to magnetization. The magnetic material of the present invention can thus be used as material of multi-pole ring-shaped magnet. Moreover, this permanent magnet containing praseodymium has a good low-temperature property. Its magnetic properties won't deteriorate due to a decrease of temperature. This permanent magnet can thus apply to low-temperature environments.

The composition formula and experimental data of performance of the present invention will be exemplified below with several examples to prove the effectiveness of the present invention.

1. Manufacturing of Alloy Ribbons

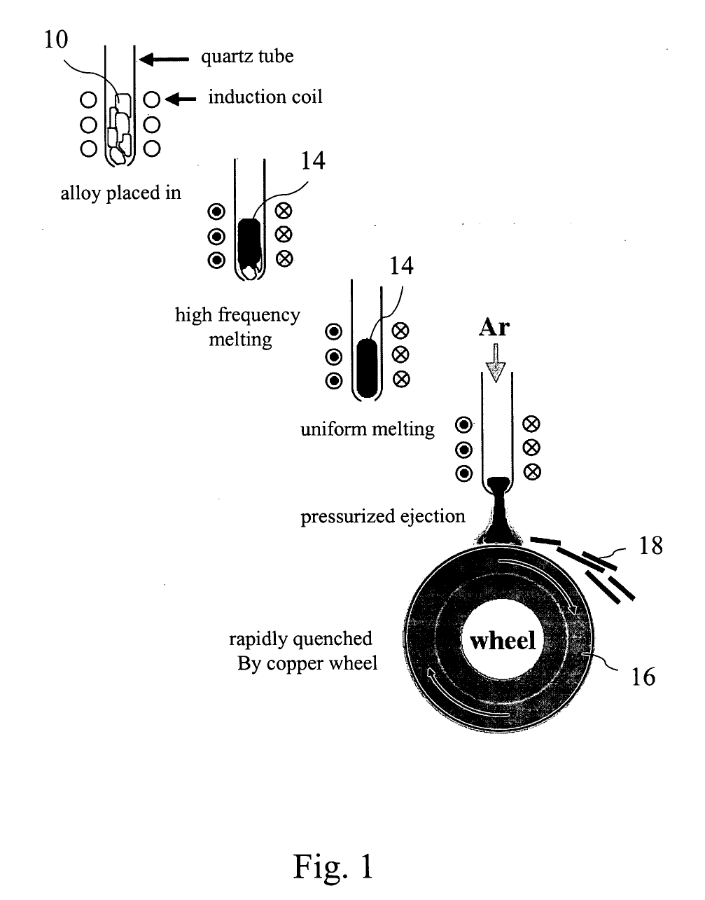

As shown in FIG. 1, alloy compositions are first converted into weight ratio. Pure elements with a degree of purity better than 99.9 wt % are taken and then polished to remove surface oxide. Next, the raw materials whose weights have been measured are smelted and cast into a copper mold to form alloy ingot. The rare earth element is added by 5 wt. % more to compensate loss during the smelting process.

Subsequently, melt-spinning is performed. The melt-spinning method is usually used in manufacturing of amorphous material today. An electromagnetic induction coil is used to provide an AC power for generating joule heat at the alloy ingot and thus melting the alloy ingot. The melted alloy is then ejected out onto the surface of a fast-rotating copper wheel for rapid cooling. Amorphous or microcrystalline alloy ribbon can be obtained, depending on the wheel speed. The ribbons are the post-annealed at 600-750° C. for 10 min to optimize the microstructures.

2. Measurement of Magnetic Property

A vibrating sample magnetometer (VSM) is used to measure the magnetic property of the alloy ribbon. First, a pulse magnetizer (about 50 kOe) is used to magnetize the alloy ribbon to accomplish saturation magnetization. Demagnetization measurement is then proceeded. Next, the VSM is used to measurement the magnetic property. A pure nickel plate is used for calibration before measurement. From the measured hysteresis curves, the remanent magnetization, intrinsic coercive force and maximum energy product of the sample ribbon can be obtained.

3. Magnetic Performance of the Ribbons

(1). Comparison of Magnetic Properties of Ternary PrFeB and NdFeB Ribbons

Table 1 shows the magnetic properties of ternary alloys Nd₀Fe_{bal.}B₅₋₁₀ and Pr₉Fe_{bal.}B₅₋₁₀. For these two series of ternary alloy, Bᵣ decreases with the increase of boron (B), but ᵢH_{c} increases with increase of B. When the atomic percentage of B is 9 at %, the magnetic energy product (BH)ₘₐₓ of both reach the maximum. Although Br of the Nd₉Fe_{bal.}B₅₋₁₀ series are higher than those of the Pr₉Fe_{bal.}B₅₋₁₀ series, ᵢH_{c} of the Pr₉Fe_{bal.}B₅₋₁₀ series are higher than those of the Nd₉Fe_{bal.}B₅₋₁₀ series. Therefore, (BH)ₘₐₓ of the Pr₉Fe_{bal.}B₅₋₁₀ series are higher than those of the Nd₉Fe_{bal.}B₅₋₁₀ series. In other words, the ternary alloy series containing Pr is superior to the ternary alloy series containing Nd within this composition range.

TABLE 1
Comparison of magnetic properties
of ternary PrFeB and NdFeB ribbons

| Composition | Bᵣ | ᵢH_{c} | (BH)ₘₐₓ |
|---|---|---|---|
| (at %) | (kG) | (kOe) | (MGOe) |
| Nd₉Fe_{bal.}B₅ | 10.2 | 4.0 | 10.5 |
| Nd₉Fe_{bal.}B₇ | 9.8 | 4.4 | 11.2 |
| Nd₉Fe_{bal.}B₈ | 9.8 | 5.1 | 13.2 |
| Nd₉Fe_{bal.}B₉ | 9.5 | 5.5 | 13.5 |
| Nd₉Fe_{bal.}B₁₀ | 9.4 | 6.1 | 12.9 |
| Pr₉Fe_{bal.}B₅ | 10.1 | 4.5 | 11.4 |
| Pr₉Fe_{bal.}B₇ | 9.7 | 5.1 | 12.5 |
| Pr₉Fe_{bal.}B₈ | 9.5 | 6.5 | 14.2 |
| Pr₉Fe_{bal.}B₉ | 9.4 | 7.2 | 14.5 |
| Pr₉Fe_{bal.}B₁₀ | 9.2 | 7.8 | 13.0 |

(2). Variation of Magnetic Properties in (Pr, Nd)FeB Alloy Ribbons

This experiment first replaces Pr in Pr_{11.76}Fe_{bal.}B_{5.88} (at %) having a composition (at %) similar to Pr₂Fe₁₄B with a trace of Nd to get alloy ribbons of (Pr, Nd)₁₁Fe₈₂B₇ (at %), and then probes into the influence to the magnetic property with Pr replaced with Nd.

Different, rotation speeds, and heat processing temperatures are used as process variables to manufacture alloy ribbons of (Pr, Nd)₁₁Fe₈₂B₇ (at %). The test results of magnetic properties under the optimum condition are listed in Table 2. As can be seen from Table 2, the optimum magnetic properties can be accomplished when the heat processing temperature is 650° C. Besides, Br increases with the increase of the content of Nd, because Nd₂Fe₁₄B phase has a higher saturation magnetization than that of the Pr₂Fe₁₄B phase, and ᵢH_{c} decreases with the increase of the content of Nd, because Nd₂Fe₁₄B phase has a lower anisotropic magnetic field than that of the Pr₂Fe₁₄B phase.

Furthermore, when the content of Nd is higher, a higher cooling rate is required for high Nd content alloy to optimize the magnetic properties.

TABLE 2
The optimum magnetic properties of alloy ribbons with
the composition of (Pr₁₋ₓNdₓ)₁₁Fe₈₂B₇ (at %)

| | | Bᵣ | ᵢH_{c} | (BH)ₘₐₓ |
|---|---|---|---|---|
| x | Condition | (kG) | (kOe) | (MGOe) |
| 0 | I = 2.2 A, Vs = 25 m/s, T_{H} = 650° C. | 9.2 | 11.0 | 17.3 |
| 0.5 | I = 2.4 A, Vs = 27 m/s, T_{H} = 650° C. | 9.8 | 8.6 | 18.0 |
| 1 | I = 2.4 A, Vs = 25 m/s | 9.9 | 8.2 | 18.4 |
| | I = 2.4 A, Vs = 30 m/s, T_{H} = 650° C. | 9.8 | 8.2 | 17.8 |

In summary, the optimum magnetic properties of ternary alloy ribbons appear in Nd₁₁Fe₈₂B₇ (at %), quenched at 25 m/s without any post-annealing. The magnetic properties are: Bᵣ=9.9 kG, ᵢH_{c}=8.2 kOe, and (BH)ₘₐₓ=18.4 MGOe. However, the optimum magnetic properties of this series occur is (Pr_{0.5}Nd_{0.5})₁₁Fe₈₂B₇ (at %), quenched at 27 m/s followed by 650° C. annealing. The optimum magnetic properties are: Bᵣ=9.6 kG; ᵢH_{c}=8.6 kOe, and (BH)ₘₐₓ=18.0 MGOe.

(3). Variation of the Content of Boron in Titanium Containing Alloy Ribbons

This experiment makes use of refractory elements addition to enhance the magnetic property of the alloy ribbon and to improve the stability of the manufacturing process. For instance, the titanium (Ti) is selected due to its easy formation with B to form B at the crystal boride which inhibit grain growth during annealing process, hence enhancing the exchange-coupling effect between grains and thus increasing the remanent magnetization and the coercive force.

This experiment explores the influence of B content on the magnetic properties of the alloy ribbons containing Ti. The results are shown in Table 3. As can be known from Table 3, Bᵣ of these two ternary alloys decreases with the increase of B content, but ᵢH_{c} increases with the increase of B. Both the magnetic energies (BH)ₘₐₓ reach the maximum when the content of B is 9 at %. Although the Bᵣ of Nd₉Fe_{bal.}Ti₂B₅₋₁₀ can be higher than those of the Pr₉Fe_{bal.}Ti₂B₅₋₁₀, the ᵢH_{c} values of the Pr₉Fe_{bal.}Ti₂B₅₋₁₀ are higher than those of the Nd₉Fe_{bal.}Ti₂B₅₋₁₀. Accordingly, (BH)ₘₐₓ values of the Pr₉Fe_{bal.}Ti₂B₅₋₁₀ may be higher than those of the Nd₉Fe_{bal.}Ti₂B₅₋₁₀.

TABLE 3
Relationship between the B content and the magnetic
properties of the Ti containing ribbons

| composition | Bᵣ | ᵢH_{c} | (BH)ₘₐₓ |
|---|---|---|---|
| (at %) | (kG) | (kOe) | (MGOe) |
| Nd₉Fe_{bal.}Ti₂B₅ | 10.3 | 4.2 | 10.5 |
| Nd₉Fe_{bal.}Ti₂B₇ | 10.1 | 4.5 | 11.6 |
| Nd₉Fe_{bal.}Ti₂B₈ | 9.8 | 5.6 | 13.7 |
| Nd₉Fe_{bal.}Ti₂B₉ | 9.8 | 7.5 | 15.9 |
| Nd₉Fe_{bal.}Ti₂B₁₀ | 9.6 | 8.9 | 14.7 |
| Pr₉Fe_{bal.}Ti₂B₅ | 10.1 | 5.0 | 13.4 |
| Pr₉Fe_{bal.}Ti₂B₇ | 9.7 | 6.5 | 14.5 |
| Pr₉Fe_{bal.}Ti₂B₈ | 9.6 | 7.8 | 15.2 |
| Pr₉Fe_{bal.}Ti₂B₉ | 9.5 | 9.5 | 17.0 |
| Pr₉Fe_{bal.}Ti₂B₁₀ | 9.2 | 11.5 | 16.2 |

In comparison with Table 1, addition of Ti can effectively improve the magnetic property of the alloy ribbon. These two tables jointly disclose that the magnetic properties of the PrFeB series is superior to that of the NdFeB series in this range of composition.

Besides, under different compositions, the optimum magnetic properties can only be accomplished using the most suitable smelting temperature and rotation speed and then through heat processing. From the experiment results, along with the decrease of B content, the condition to achieve the optimum magnetic properties is to increase of the cooling rate. On the other hand, increase of the B content, the alloy ribbon more easily crystallizes so that a lower cooling rate is sufficient to have a fine grain size.

(4). Addition of Trace Refractory Element

The results of this experiment further prove that addition of refractory element increases the remanent magnetization (Bᵣ) and the intrinsic coercive force (ᵢH_{c}), hence enhancing the maximum energy product.

Besides, this experiment further measures the magnetic properties for alloy ribbons with two or more refractory elements. The results are shown in FIG. 5. As can be seen from the table, cosubstitution of Ti, niobium (Nb) and zirconium (Zr) for Fe can enhance maximum energy product of the alloy ribbon.

TABLE 4
Influence to the magnetic properties
due to addition of refractory element

| composition | Bᵣ | ᵢH_{c} | (BH)ₘₐₓ |
|---|---|---|---|
| (at %) | (kG) | (kOe) | (MGOe) |
| Pr₉Fe_{bal.}B₉ | 9.4 | 7.2 | 14.5 |
| Pr₉Fe_{bal.}Ti₂B₉ | 9.5 | 9.5 | 17.0 |
| Pr₉Fe_{bal.}Cr₂B₇ | 9.2 | 10.2 | 14.5 |
| Pr₉Fe_{bal.}Nb₂B₈ | 9.4 | 10.5 | 16.9 |
| Pr₉Fe_{bal.}Zr₂B₉ | 9.4 | 10.3 | 16.5 |
| Pr₉Fe_{bal.}B₁₀ | 9.3 | 11.0 | 15.9 |

TABLE 5
Influence to the magnetic properties due
to refractory elements cosubstitution

| composition | Bᵣ | ᵢH_{c} | (BH)ₘₐₓ |
|---|---|---|---|
| (at %) | (kG) | (kOe) | (MGOe) |
| Pr₉Fe_{bal.}B₉ | 9.4 | 7.2 | 14.5 |
| Pr₉Fe_{bal.}Ti₂B₉ | 9.5 | 9.5 | 17.0 |
| Pr₉Fe_{bal.}Ti₁Nb₁B₉ | 9.6 | 9.8 | 17.6 |
| Pr₉Fe_{bal.}Ti₁Zr₁B₉ | 9.5 | 9.5 | 17.4 |
| Pr₉Fe_{bal.}Nb₁Zr₁B₉ | 9.4 | 9.4 | 16.9 |
| Pr₉Fe_{bal.}Ti₁Nb_{0.5}Zr_{0.5}B₉ | 9.6 | 10.0 | 18.0 |

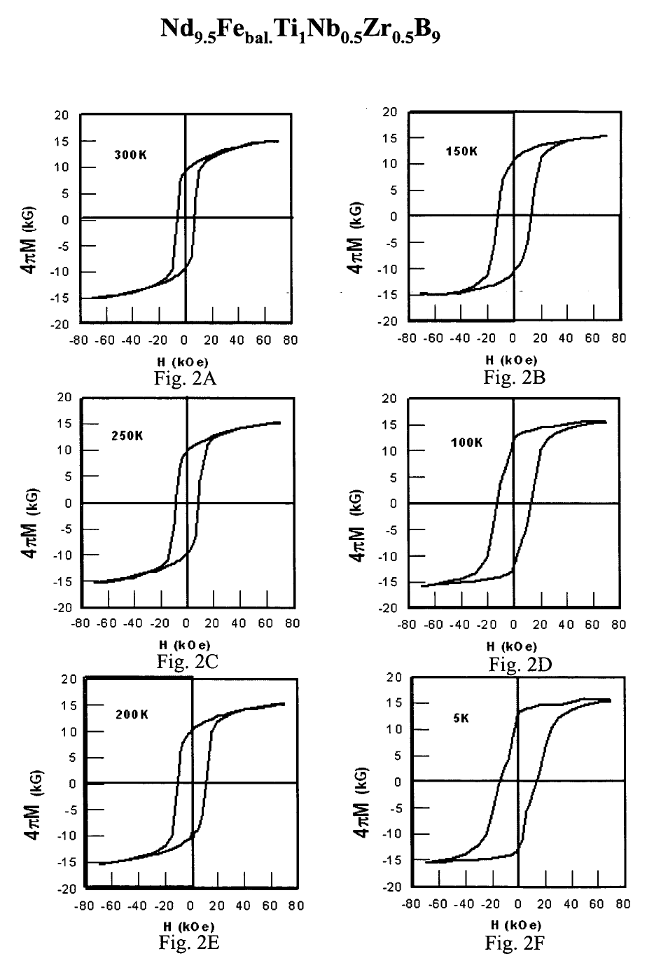

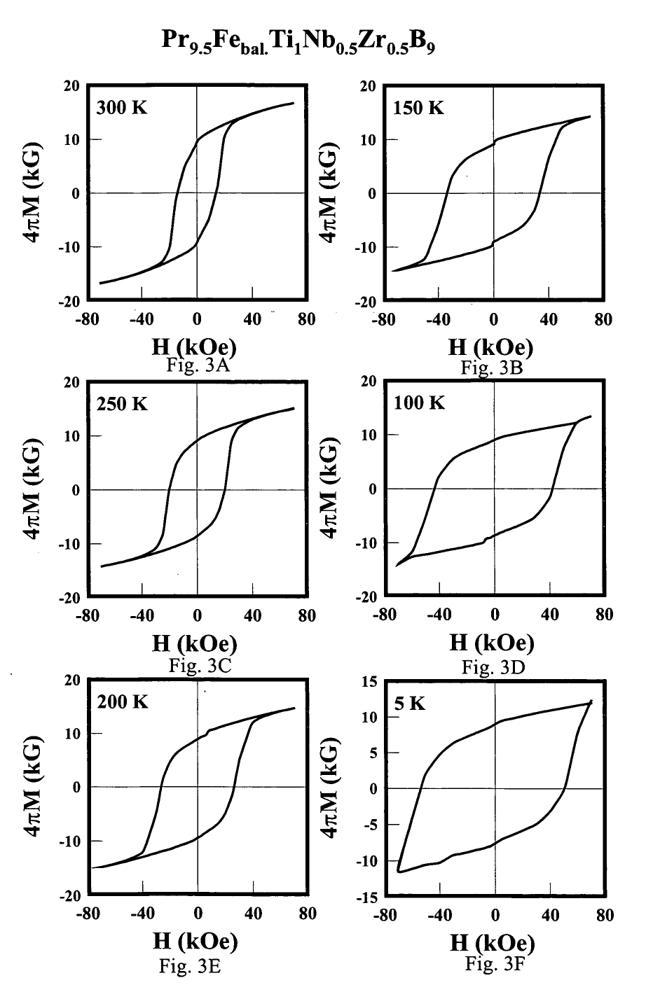

Additionally, hysteresis curves of alloy ribbon whose composition is Nd_{9.5}Fe_{bal.}Ti₁Nb_{0.5}Zr_{0.5}B₉ and Pr_{9.5}Fe_{bal.}Ti₁Nb_{0.5}Zr_{0.5}B₉, respectively, are compared. Their magnetic properties are shown in FIGS. 2A to 2F and 3A to 3F, respectively.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A magnetic material containing praseodymium being formed of a composition whose atomic percentage composition is (PrNd)ₓT_{100-x-y-z}X_{y}Q_{z} where (PrNd) is one or more than one element selected from the group composed of praseodymium and neodymium and contains definitely praseodymium, T is one or more than one element selected from the group composed of iron and cobalt and contains-definitely iron, X is a refractory element, Q is one or more than one element selected from the group composed of boron and carbon, the composition ratios x, y and z satisfying:
8≦x≦11 atomic percentage;
0≦y≦3 atomic percentage; and
6≦z≦12 atomic percentage.

2. The magnetic material containing praseodymium as claimed in claim 1, wherein said refractory element is at least one element selected from the group composed of titanium, vanadium, niobium, hafnium, chromium, zirconium, molybdenum, and tungsten.

3. The magnetic material containing praseodymium as claimed in claim 1 including two kinds of magnetic phases: soft magnetic phases and a hard magnetic phase, said soft magnetic phases have a crystalline grain size of 10 to 30 nm and have a volume fraction of 5 to 25%, while said hard magnetic phase has a crystalline grain size of 20 to 50 nm and has a volume percentage of 75 to 95%.

4. The magnetic material containing praseodymium as claimed in claim 3, wherein said soft magnetic phases have a crystalline grain size of 10 to 20 nm, while said hard magnetic phase has a crystalline grain size of 20 to 30 nm.

5. The magnetic material containing praseodymium as claimed in claim 1, which can apply to multi-pole ring-shaped magnets.

6. The magnetic material containing praseodymium as claimed in claim 1, which can be manufactured into magnetic
